(19) United States
(12) Patent Application Publication
(10) Pub. No.: US 2008/0163496 A1
(43) Pub. Date: Jul. 10, 2008

(54) Method and System of Feeding Line on a Line Trimmer

(76) Inventor: Gregory Mark Huseman, Canyon, TX (US)

Correspondence Address: CONLEY ROSE, P.C.;David A. Rose, P. O. BOX 3267, HOUSTON, TX, 77253-3267, US

(21) Appl. No.: 11/621,656

(22) Filed: Jan. 10, 2007

(51) Int. Cl. A01D 34/416

(52) U.S. Cl. 30/276

(57) ABSTRACT

A method and system of feeding line on a line trimmer. At least some of the illustrative embodiments are line trimmers comprising a motor, a cutting head coupled to the motor (the cutting head having a line inlet along an axis of rotation of the cutting head, and a line outlet in a direction substantially perpendicular to the line inlet, wherein trimmer line extends through the line inlet and then out the line outlet), an elongated shaft that supports the cutting head on a distal end, and a line feed system coupled to the elongated shaft. The line feed system has a first configuration that prevents feeding of the trimmer line toward the line inlet, and a second configuration that allows substantially unimpeded movement of the trimmer line toward the line inlet, the movement caused by centrifugal force on the trimmer line extending from the line outlet of the cutting head.

### BACKGROUND

Line trimmers for yard work, such as the WEEDEATER® or ECHO® brand products, use polymer-based trimmer line as the mechanism to cut grass, weeds, small trees and the like. When the trimmer line hits rocks, concrete and thick trunks, the trimmer line is ablated and/or broken off. First generation line trimmers required the user to manually extend trimmer line from a spool by at least partially disassembling the spool, a time consuming process. Second generation line trimmers store a length of trimmer line on or within the rotating spool, and the line is fed in operation by hitting the spool on the ground to momentarily release the trimmer line to extend from the spool. While a vast improvement over first generation devices, only a limited amount of trimmer line may be stored in or by the spool in the second generation devices. Moreover, reloading the spool with additional trimmer line is a somewhat complicated process, a process that discourages use of line trimmers by some consumers.

### BRIEF DESCRIPTION OF THE DRAWINGS

For a detailed description of exemplary embodiments of the invention, reference will now be made to the accompanying drawings in which:

FIG. 1 shows a line trimmer in accordance with at least some embodiments;

FIG. 2 shows an exploded perspective view of a mechanical assembly that transfers rotational energy of a drive shaft to the cutting head;

FIG. 3 shows the distal end of a curved shaft line trimmer in accordance with alternative embodiments;

FIG. 4 shows a line trimmer where the motor directly couples to the cutting head in accordance with alternative embodiments;

FIG. 5 shows a cross-sectional view of a cutting head;

FIG. 6 shows a line feed system in accordance with at least some embodiments;

FIG. 7 shows alternative embodiments of a line catch; and

FIG. 8 shows a method in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Also, the term “couple” or “couples” is intended to mean either an indirect or direct connection. Thus, if a first device couples to a second device, that connection may be through a direct connection or through an indirect connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

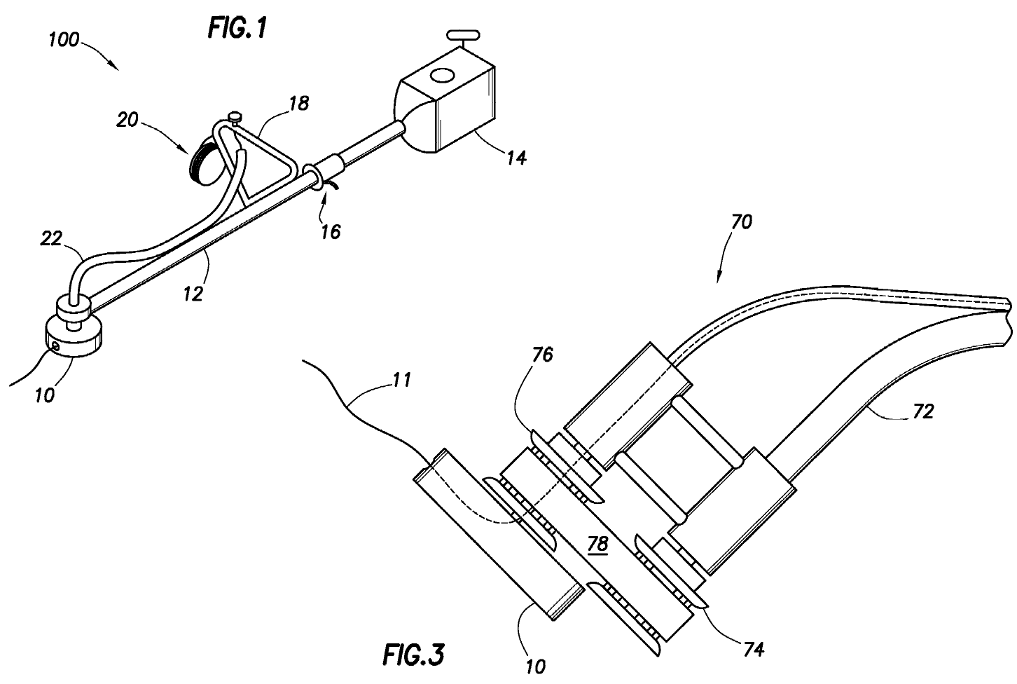

FIG. 1 illustrates a line trimmer 100 in accordance with at least some embodiments. In particular, FIG. 1 illustrates a line trimmer having a cutting head 10 coupled to a distal end of an elongated shaft 12, and a motor 14 coupled to a proximal end of the elongated shaft 12. The particular line trimmer illustrated by FIG. 1 is known as straight shaft line trimmer because the elongated shaft 12 is straight between the motor 14 and cutting head 10. A drive shaft (not shown) couples the motor 14 to the cutting head 10, and resides within the elongated shaft 12. The motor 10 is illustrated as a gas powered motor, such as a two- or four-cycle engine, but in alternative embodiments the motor 10 is an electric motor. Throttle 16 couples to the elongated shaft 12, and provides throttle control for the motor 14. Also, a handle 18 couples to a medial portion of the elongated shaft 12.

In accordance with embodiments of the invention, the string for the line trimmer, referred to herein as the trimmer line, feeds to the cutting head from a spool or other reserve 20 of trimmer line. Unlike previous line trimmers where extra trimmer line is held on a spool that is within and that rotates with the cutting head 10, the various embodiments feed trimmer line to the cutting head 10 from a reserve of trimmer line held external to the cutting head 10. Feeding trimmer line to the cutting head 10 as illustrated in FIG. 1 provides for a much larger reserve of trimmer line, and in some cases one hundred feet or more. FIG. 1 illustrates the trimmer line reserve as coupled to the handle 18, but in alternative embodiments the reserve of trimmer line may couple to any suitable portion of the line trimmer 100. In some embodiments, the trimmer line enters a conduit 22 which leads the trimmer line to a line inlet of the cutting head 10; however, a conduit is not strictly required, as the trimmer line may feed to the line inlet after running through one or more eyelets (e.g., such as used on a fishing rod), or may feed to the cutting head 10 without any further guides.

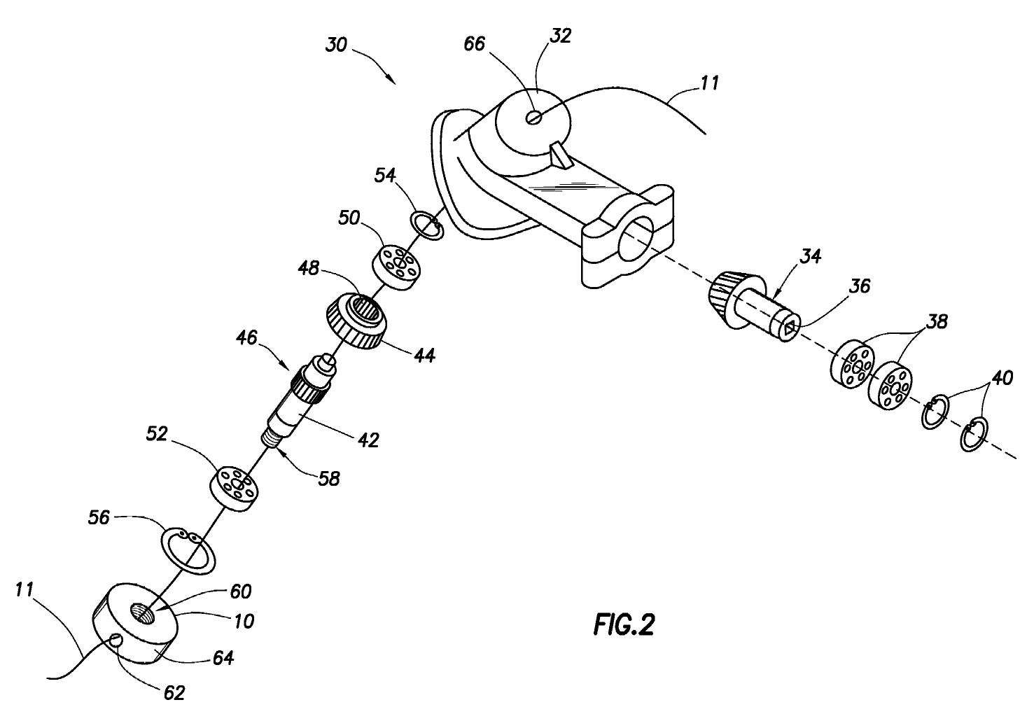

In order to feed the trimmer line to the cutting head 10 in the manner illustrated in FIG. 1, the trimmer line enters the cutting head 10 along an axis of rotation of the cutting head 10. In order to show feeding trimmer line along an axis of rotation of the cutting head 10, FIG. 2 illustrates an exploded perspective view of a mechanical assembly 30 that transfers rotational energy of a drive shaft to the cutting head 10. In particular, the mechanical assembly 30 comprises a housing 32 within which the various illustrated components (except the cutting head 10) reside. The drive shaft within the elongated shaft 12 couples to a pinion gear 34, and particularly to the aperture 36. The pinion gear 34 is held in place within the housing 32 by way of a plurality of bearings 38 and c-rings or clips 40. The rotational energy imparted to the pinion gear 34 is in turn imparted to shaft 42 through a pinion gear 44 that mates with pinion gear 34. The pinion gear 44 is shown to couple to the shaft 42 by way of splines 46 on an outer diameter of the shaft 42 and splines 48 on an inner diameter of the pinion gear 44, but any suitable mechanism for providing mating gears for pinion gear 34 may be equivalently used. The shaft 42 is held in place by bearing 50 on one end and bearing 52 on a second end, as well as corresponding ring clips 54 and 56. When assembled, the threaded end 58 of the shaft 42 extends below the housing 32, and the cutting head 10 threadingly couples to the shaft 58.

Cutting head 10 has a line inlet 60 coaxial with the threads used to couple the cutting head 10 to the shaft 42. Because the shaft 42 turns the cutting head 10 when the line trimmer 100 is in operation, the line inlet thus lies along the axis of rotation of the cutting head 10. Within the cutting head 10 the trimmer line 11 turns and extends out of a line outlet 62 on an outer face 64 of the cutting head 10. When the cutting head 10 is turned during operation of the line trimmer 100, the portion of the trimmer line 11 extending beyond the line outlet 62 of the cutting head 10 defines a plane, and the plane is substantially perpendicular to the axis of rotation of the cutting head. In order for the trimmer line 11 to enter the cutting head 10 in the embodiments illustrated in FIG. 2, the shaft 42 has an axial bore through which the trimmer line 11 passes. Moreover, the housing 32 has an aperture 66 through which the trimmer line 11 extends (in FIG. 2 the conduit 22 is omitted). In some embodiments, the outside diameter of the upper end of the shaft 42 has a seal that rotationally seals to the inside diameter of the aperture 66 to reduce the possibility of contaminates entering the housing 32.

The embodiments illustrated in FIGS. 1 and 2 relate to straight shaft line trimmers. However, feeding trimmer line from a reserve 20 above the cutting head 10 is also operational in curved shaft line trimmers. FIG. 3 illustrates the distal end of a curved shaft line trimmer 70 in accordance with alternative embodiments. In particular, these embodiments also comprise an elongated shaft 72, but the shaft curves at its distal end, rather than using gears to transfer the rotational energy. Thus, within the elongated shaft 72 resides a flexible drive shaft that couples to a first gear 74. The first gear 74 in turn couples rotational energy to a second gear 76. FIG. 3 shows a belt 78 coupling the gears 74 and 76, but in alternative embodiments the gears may be coupled directly, or by way of a chain. The cutting head couples to the second gear 76 and associated shaft (not specifically shown). Much like the shaft of FIG. 2, the shaft associated with gear 76 has an axial bore, and the trimmer line 11 extends through the bore to the line inlet of the cutting head 10, as shown in dashed lines.

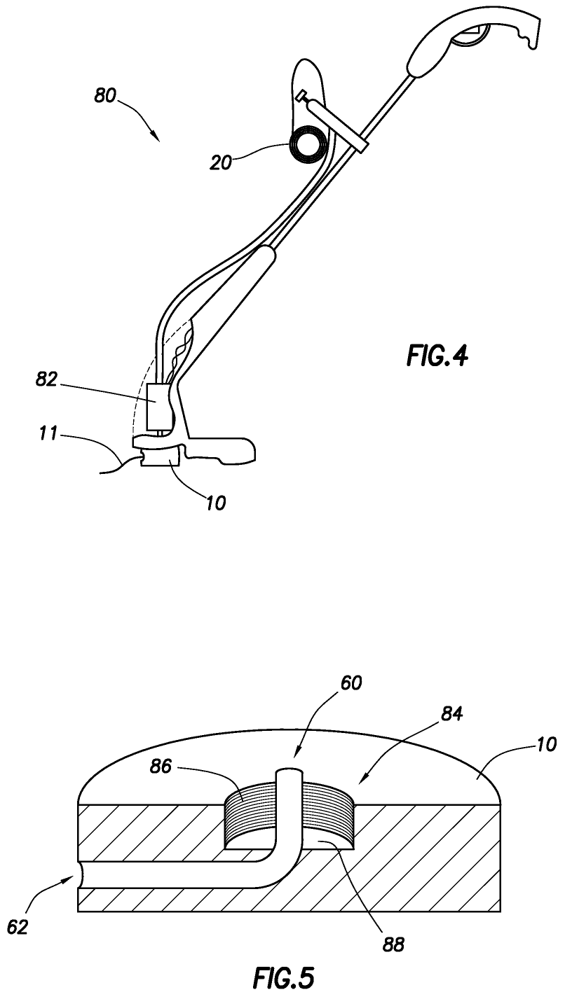

The embodiments of FIGS. 1-3 relate to line trimmers where the motor 14 is displaced from the cutting head 10 such that a drive shaft is used to transfer the rotational energy. However, feeding trimmer line from a reserve 20 above the cutting head 10 is also operational in direct coupled line trimmers. FIG. 4 illustrates an elevational cut-away view of a line trimmer 80 where the motor 82 (in this case an electric motor) is directly coupled to the cutting head 10. In order to feed the trimmer line 11 from the reserve 20, the trimmer line 11 passes through an axial bore of the shaft of the rotor portion of the motor 82.

FIG. 5 illustrates a cut-away view of a cutting head 10 in accordance with the various embodiments. In particular, cutting head 10 comprises the line outlet 62 fluidly coupled to line inlet 60. The line inlet 60 is coaxial with the axis of rotation of the cutting head 10, and thus the line inlet 60 is substantially centered within the blind aperture having internal threads 86. The internal threads 86 mate with the threads on the outer diameter of the shaft 42 (FIG. 2). However, internal threads on the cutting head 10 are not required. In alternative embodiments the cutting head 10 has a male fitting that is externally threaded, and the shaft to which the cutting head couples has a mating female fitting that is internally threaded. In yet still other embodiments, the shaft couples to the cutting head 10 by mechanisms other than threaded connections (e.g., set screws or friction fit). Moreover, line inlet 60 is shown to extend into the blind aperture, but in alternative embodiments is flush with the floor 88 of the blind aperture.

Regardless of the precise type of line trimmer used, when the line trimmer is in operation the portion of the trimmer line 11 extending beyond the cutting head 10 is the trimmer line used to cut vegetation. Through use, the length of the trimmer line extending beyond the cutting head 10 shortens. For example, through contact with hard or abrasive objections (e.g., concrete, rocks or bricks), the trimmer line thins and in some cases is breaks off. In the various embodiments of the invention feeding trimmer line 11 to the cutting head 10 (alternatively referred to as lengthening the trimmer line extending beyond the cutting head 10), is accomplished by allowing the trimmer line 11 to be pulled from the reserve 20. In particular, the trimmer line in the cutting head 10 and the trimmer line extending beyond the front face 64 of the cutting head 10 experience centrifugal force when the cutting head 10 is rotating. In the various embodiments, the centrifugal force pulls the trimmer line 11 from the reserve. Thus, feeding trimmer line to the cutting head 10 or lengthening the trimmer line extending beyond the cutting head 10 involves releasing trimmer line to be pulled from the reserve 20 by centrifugal force. Stated otherwise, there is no need to have a mechanical system to force or push the trimmer line 11 towards the line inlet of the cutting head, as the centrifugal force associated with rotation is more than sufficient to pull the trimmer line.

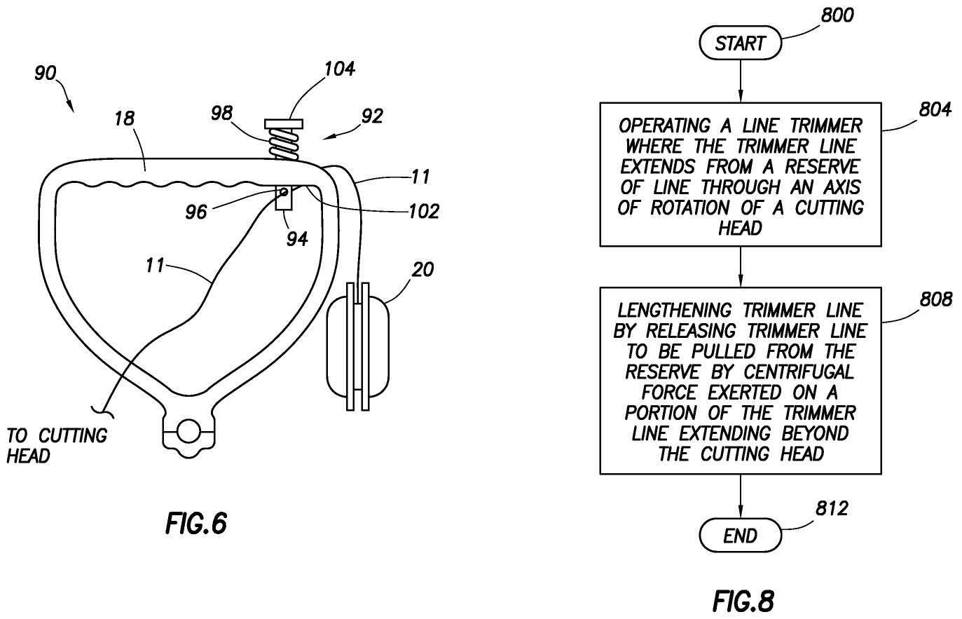

FIG. 6 illustrates a line feed system 90 in accordance with at least some embodiments. In particular, the line feed system 90 in some embodiments comprises a line catch 92 associated with the trimmer line 11. As discussed above, centrifugal force is sufficient to pull the trimmer line when in operation, and thus the line feed system 90, here the line catch 92, holds the trimmer line against movement caused by the centrifugal forces when an operator of the line trimmer does not wish to lengthen the trimmer line. In accordance with these embodiments, the line catch 92 comprises a shaft 94 having an aperture 96 therein. The trimmer line 11 extends from the reserve 20 (e.g., the package in which the trimmer line is packed from the factory) through the aperture 96 and then to the cutting head 10. A bias mechanism, in this illustrative case a coil spring 98, biases the shaft to occlude the aperture, such as against surface 102 of handle 18. The partial occlusion of the aperture 96 acts to clamp the trimmer line 11 against movement. When a user desires to feed trimmer line 11, with the cutting head 10 rotating the user pushes the button 104. Pushing the button 104 compresses spring 98 and releases the trimmer line 11 for substantially unimpeded movement from the reserve 20, through the aperture 96, and to the cutting head 10.

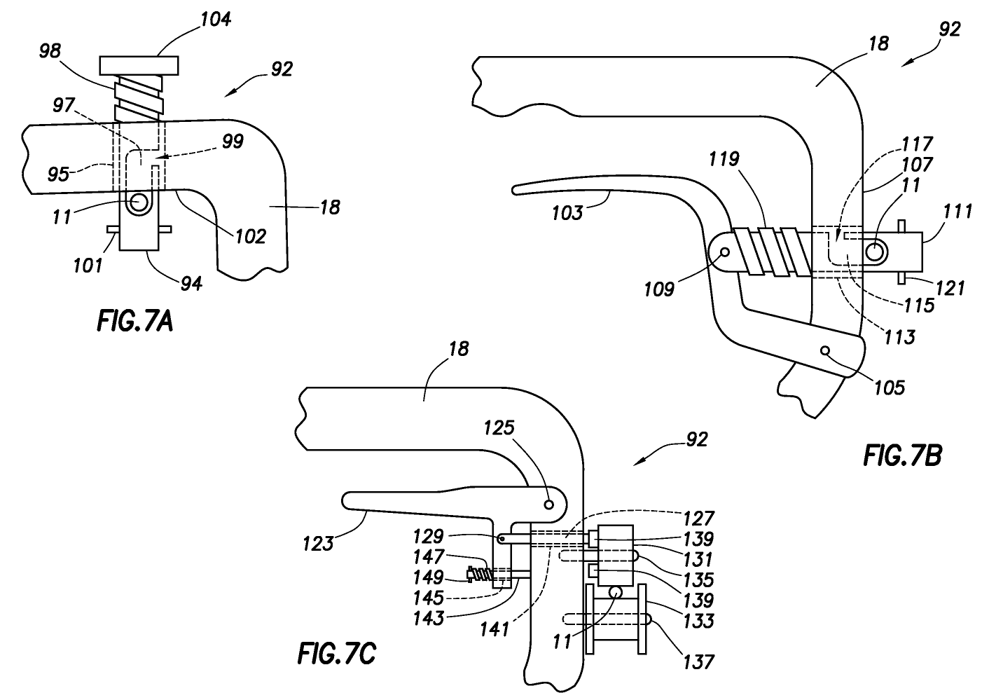

FIG. 7 illustrates various alternative embodiments of the line catch 92. The line catch 92 as shown in FIG. 7A is similar to the line catch 92 of FIG. 6; however, in the embodiments of FIG. 7A the shaft 94, which passes through a handle opening 95, comprises a slotted aperture 97 having a slot opening 99. The slotted aperture 97 and the slot opening 99 allow the trimmer line 11 to be loaded into the line catch 92 after the trimmer line 11 has been fed through the cutting head 10. In particular, pushing the button 104 compresses the spring 98, revealing the slot opening 99, and allowing the trimmer line 11 to be loaded into the slotted aperture 97. The loaded trimmer line 11 is then held against movement against the surface 102 of the handle 18 by way of the coil spring 98, which acts as a bias mechanism to partially occlude the slotted aperture 97. When a user desires to the feed trimmer line 11, with the cutting head 10 rotating the user pushes the button 104. Pushing the button 104 compresses the spring 98 and releases the trimmer line 11 for substantially unimpeded movement from the reserve 20, through the slotted aperture 97, and to the cutting head 10. When there is no trimmer line 11 passing through the slotted aperture 97, a pin or c-ring 101 attached to the shaft 94 presses against the surface 102 of the handle 18 to keep the shaft 94 positioned substantially through the handle opening 95.

FIG. 7B shows a line catch 92 having a lever 103 rotatably coupled to a handle 18 by way of a pin 105 and coupled to a shaft 111 by way of a pin 109. The shaft 111, which passes through a handle opening 113, comprises a slotted aperture 115 having a slot opening 117. The slotted aperture 115 and the slot opening 117 allow the trimmer line 11 to be loaded into the line catch 92 after the trimmer line 11 has been fed through the cutting head 10. In particular, pulling the lever 103 compresses a spring 119, revealing the slot opening 117, and allowing the trimmer line 11 to be loaded into the slotted aperture 115. The loaded trimmer line 11 is then held against movement against a surface 107 of the handle 18 by way of the coil spring 119, which acts as a bias mechanism to partially occlude the slotted aperture 115. When a user desires to the feed trimmer line 11, with the cutting head 10 rotating the user pulls the lever 103. Pulling the lever 103 compresses the spring 119 and releases the trimmer line 11 for substantially unimpeded movement from the reserve 20, through the slotted aperture 115, and to the cutting head 10. When there is no trimmer line 11 passing through the slotted aperture 115, a pin or c-ring 121 attached to the shaft 111 presses against the surface 107 of the handle 18 to keep the shaft 111 positioned substantially through the handle opening 113.

FIG. 7C illustrates a line catch 92 having a lever 123 rotatably coupled to a handle 18 by way of a pin 125. The lever 123 is also coupled to a pin or shaft 127 by way of a pin 129. A pin or shaft 143 comprises a first end coupled to the handle 18, passes through the lever 123 by way of an opening 145, and comprises a second end having a spring 147 and a pin or c-ring 149. The catch 92 further comprises a first roller 131 and a second roller 133. The first roller 131 rotates about a shaft 135 that is coupled to the handle 18, and the second roller 133 rotates about a shaft 137 that is coupled to the handle 18. The first roller 131 also comprises at least one stop 139 that interacts with the pin or shaft 127. In particular, the shaft 127 passes through a handle opening 141 and catches the stop 139 such that the first roller 131 is prevented from movement in at least one direction. The trimmer line 11 is loaded into the line catch 92 such that the trimmer line 11 passes between the first roller 131 and the second roller 133. When a user desires to the feed trimmer line 11, with the cutting head 10 rotating the user pulls the lever 123. Pulling the lever 123 compresses the spring 147, pulls back the pin 127, and allows the first roller 131 to freely rotate. Thus, the second roller 133 also freely rotates by way of the trimmer line 11 being released for substantially unimpeded movement from the reserve 20, between the two rollers, and to the cutting head 10. When the lever 123 is released, the pin 127 catches the next stop 139 and causes the rollers to stop rotating and causes the trimmer line 11 to substantially cease its movement between the rollers.

In a model built to test the viability of the operating a line trimmer in accordance with the various embodiments described above, it was determined that certain types of trimmer line work better than others. For example, trimmer line having a substantially smooth surface works better than serrated surface trimmer line, which serrated surface trimmer line tends to break within the cutting head at the elbow where the trimmer line turns from co-axial with the axis of rotation of the cutter head to perpendicular to the axis of rotation. Moreover, trimmer line with substantially circular cross-section works better than trimmer line with triangular or square cross-section, as again the non-circular trimmer line tends to break within the cutting head. Finally, trimmer line that is coated with a lubricant tends to work better than non-lubricated trimmer line.

FIG. 8 illustrates a method in accordance with at least some embodiments. In particular, the method starts (block 800) and proceeds to operating a line trimmer where the trimmer line extends from a reserve of line through an axis of rotation of a cutting head and out an aperture on a cutting head (block 804). The line trimmer may take many forms. In some embodiments the line trimmer is a straight shaft line trimmer with a gasoline or electric motor. In other embodiments, the line trimmer is a curved shaft line trimmer with a gasoline or electric motor. In yet still other embodiments, the line trimmer has an electric motor directly coupled to the cutting head. Regardless of the precise type of line trimmer, at some point in the operation the user lengthens the trimmer line extending from the cutting head during operation by releasing the trimmer line to be pulled from the reserve by centrifugal force exerted on a portion of the trimmer line extending beyond the aperture on the cutting head (block 808) and the process ends (block 812).

The above discussion is meant to be illustrative of the principles and various embodiments of the present invention. Numerous variations and modifications will become apparent to those skilled in the art once the above disclosure is fully appreciated. For example, while the line feed mechanism is proximate to the handle 18, the line feed mechanism may be placed at any suitable location (e.g., proximate to the cutting head and operated electrically, or by a cable). Moreover, while the various embodiments are disclosed as part of an entire line trimmer system, the cutting head of the various embodiments may also be an attachment which turns a multipurpose tool into a line trimmer. It is intended that the following claims be interpreted to embrace all such variations and modifications.

What is claimed is:

1. A line trimmer comprising:
a motor;
a cutting head coupled to the motor, the cutting head having a line inlet along an axis of rotation of the cutting head, and a line outlet in a direction substantially perpendicular to the line inlet, wherein trimmer line extends through the line inlet and then out the line outlet;
an elongated shaft that supports, on a distal end, the cutting head; and
a line feed system coupled to the elongated shaft, the line feed system having a first configuration that prevents feeding of the trimmer line toward the line inlet, and a second configuration that allows substantially unimpeded movement of the trimmer line toward the line inlet, the movement caused by centrifugal force on the trimmer line extending from the line outlet of the cutting head.

2. The line trimmer as defined in claim 1 wherein the line feed system further comprises a line catch coupled to the elongated shaft, in the first configuration the line catch couples to the trimmer line and prevents movement of the trimmer line, and in the second configuration the line catch is decoupled from the trimmer line.

3. The line trimmer as defined in claim 2 wherein the line catch further comprises:
a shaft having an aperture, the trimmer line extends through the aperture;
a bias mechanism that biases the aperture to clamp the trimmer line in the first configuration.

4. The line trimmer as defined in claim 3 wherein the bias mechanism further comprises a spring that biases the shaft.

5. The line trimmer as defined in claim 1 further comprising a handle coupled to a medial portion of the elongated shaft, the line catch mechanism coupled to the handle.

6. The line trimmer as defined in 1 wherein movement of the trimmer line toward the cutting head is caused exclusively by centrifugal force on the portion of the trimmer line protruding from the cutting head.

7. The line trimmer as defined in claim 1 wherein the motor couples to the elongated shaft on the distal end proximate to the cutting head.

8. The line trimmer as defined in claim 1 further comprising:
a drive shaft disposed within the elongated shaft;
said motor supported by the elongated shaft on a proximal end, and the motor coupled to the cutting head by way of the drive shaft.

9. The line trimmer as defined in claim 1 wherein the motor is one or more selected from the group consisting of: an electric motor; or a gasoline powered motor.

10. The line trimmer as defined in claim 1 wherein the trimmer line has a substantially circular cross-section.

11. The line trimmer as defined in claim 1 wherein the trimmer line has a substantially smooth other surface.

12. The line trimmer as defined in claim 1 wherein an outer surface of the trimmer line is coated with a lubricant.

13. The line trimmer as defined in claim 2 wherein the line catch further comprises:
a shaft having a slotted aperture, the trimmer line extends through the slotted aperture;
a bias mechanism that biases the slotted aperture to clamp the trimmer line in the first configuration.

14. The line trimmer as defined in claim 13 wherein the line catch further comprises a lever coupled to the shaft.

15. The line trimmer as defined in claim 2 wherein the line catch further comprises:
a lever;
a shaft coupled to the lever;
a first roller;
a second roller operationally coupled to the shaft, the trimmer line extends between the first roller and the second roller;
wherein the shaft locks the second roller against movement in the first configuration.

16. An attachment for a line trimmer comprising:
a cutting head having an axis of rotation, the cutting head configured to releasably couple to a drive shaft of a line trimmer;
a line inlet aperture associated with the cutting head, the aperture aligned substantially with the axis of rotation of the cutting head;
a line outlet aperture on an outer face of the cutting head, the line outlet aperture fluidly coupled to the line inlet aperture, and trimmer line protruding from the line outlet aperture defines a plane perpendicular to the axis of rotation when the cutting head is rotating;
a line feed system associated with the attachment, the line feed system having a first configuration that prevents feeding of the trimmer line, and a second configuration that allows substantially unimpeded movement of the trimmer line toward the line inlet, the movement caused by centrifugal force on the trimmer line extending from the line outlet of the cutting head.

17. The attachment as defined in claim 16 wherein the line feed system further comprises a line catch that in the first configuration couples to the trimmer line and prevents movement of the trimmer line, and in the second configuration allows substantially unimpeded feeding of the trimmer line into the line inlet.

18. The attachment for a line trimmer as defined in claim 17 wherein the line catch mechanism further comprises:
a shaft having an aperture, the trimmer line extends through the aperture;
a bias mechanism that biases the aperture to clamp the trimmer line in the first configuration.

19. The attachment for a line trimmer as defined in claim 18 wherein the bias mechanism further comprises a spring that biases the shaft.

20. The attachment for a line trimmer as defined in 16 wherein movement of the trimmer line toward the cutting head is caused exclusively by centrifugal force on the portion of the trimmer line protruding from the cutting head.

21. The attachment for a line trimmer as defined in claim 16 wherein the trimmer line has one or more attributes selected from the group consisting of: a substantially circular cross-section; a substantially smooth other surface; or an outer surface of the trimmer line is coated with a lubricant.

22. The attachment for a line trimmer as defined in claim 17 wherein the line catch further comprises:
a shaft having a slotted aperture, the trimmer line extends through the slotted aperture;
a bias mechanism that biases the slotted aperture to clamp the trimmer line in the first configuration.

23. The attachment for a line trimmer as defined in claim 22 wherein the line catch further comprises a lever coupled to the shaft.

24. The attachment for a line trimmer as defined in claim 17 wherein the line catch further comprises:
a lever;
a shaft coupled to the lever;
a first roller;
a second roller operationally coupled to the shaft, the trimmer line extends between the first roller and the second roller;
wherein the shaft locks the second roller against movement in the first configuration.

25. A method comprising:
operating a line trimmer wherein the trimmer line extends from a reserve of line through an axis of rotation of a cutting head and out an aperture on a cutting head;
lengthening trimmer line extending from the cutting head during operation by releasing trimmer line to be pulled from the reserve by centrifugal force exerted on a portion of the trimmer line extending beyond the aperture on the cutting head.

26. The method as defined in claim 25 wherein releasing further comprises decoupling a clamp mechanism.

27. The method as defined in claim 26 were decoupling further comprises moving an aperture through which the trimmer line extends away from a surface that occludes the aperture.
